(19) United States
(12) Patent Application Publication
(10) Pub. No.: US 2025/0369589 A1
(43) Pub. Date: Dec. 4, 2025

(54) Deglaring Films for Illumination Systems

(71) Applicant: BrightView Technologies, Inc., Durham, NC (US)

(72) Inventors: Karl Kissa, Brewster, MA (US); Bing Shen, Cary, NC (US); Kenneth L. Walker, Semora, NC (US)

(73) Assignee: BrightView Technologies, Inc., Durham, NC (US)

(21) Appl. No.: 19/224,646

(22) Filed: May 30, 2025

Related U.S. Application Data
(60) Provisional application No. 63/655,851, filed on Jun. 4, 2024.

(51) Int. Cl. F21V 5/00

(52) U.S. Cl. CPC F21V 5/005

(57) ABSTRACT

A deglaring film includes a substrate having a first surface that accepts input light along a nadir and having an input light distribution comprising a Lambertian light distribution and a second surface comprising a plurality of prism microstructures each prism microstructure having a peak-shaped cross section. The deglaring film transforms the input light to output light emerging from the second surface along the nadir and having an output light distribution with an intensity of light angles greater than 60 degrees from the nadir being less an intensity of light of the input light distribution greater than 60 degrees from the nadir, wherein an apex angle of some of the plurality of prism microstructures being chosen such that the output light distribution has a glare below a predetermined level in an axis oriented along the apex direction and an output light distribution axis orthogonal to the apex direction.

### CROSS-REFERENCE TO RELATED APPLICATION

The present application is a Non-Provisional of U.S. Provisional Patent Application No. 63/655,851 entitled “Deglaring Films for Illumination Systems”, filed on Jun. 4, 2024. The entire contents of U.S. Provisional Patent Application No. 63/655,851 are herein incorporated by reference.

### INTRODUCTION

In many illumination systems, targeted areas to be illuminated are much larger than an emitting area of the light sources. Many artificial light sources emit light in an approximately Lambertian distribution. In many cases the Lambertian distribution emits light at high angles, for example, angles from 65 to 90 degrees relative to nadir. Nadir refers, for example, to the direction that points directly downward from a light source that is mounted overhead. The nadir direction is typically normal to a plane that contains the light source. In offices and other environments, it is often desirable to reduce or minimize light emitted in the 65 to 90-degree angle range. This is at least because of discomfort that viewers can experience in directly viewing the lights from those angles, and/or because of reflections of light from angles in that range from displays, work surfaces, and other objects can enter a line of sight. Glare from light sources, generally caused by intense light directed into a line of sight of a viewer, can cause various levels of difficulty ranging from mild discomfort to impairment of ability to see and perform tasks. As such, there is a need for illumination systems with reduced high-angle intensity and/or reduced glare and/or controlled glare. These improved illumination systems need to be easy to manufacture with low cost and high performance. These illumination systems also need to be compatible with various light sources used in illumination systems. Light sources include, for example, LEDs and various fluorescent, incandescent and halogen bulbs.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale; emphasis instead generally being placed upon illustrating principles of the teaching. The drawings are not intended to limit the scope of the Applicant's teaching in any way.

FIG. 1 illustrates a chart showing a Lambertian intensity distribution with a Full Width Half Maximum (FWHM) of 120 degrees.

FIG. 2 illustrates a chart showing the light distribution of a Lambertian light source after passing through a linear prism film.

FIG. 3 illustrates a configuration of a known goniometric apparatus used to measure the light distribution from a luminaire.

FIG. 4 illustrates an equation for a Unified Glare Rating (UGR) that highlights the key contributions to glare ratings for illumination systems.

FIG. 5 illustrates a table showing UGR data for an individual light with 190 values corresponding to different room sizes and surface reflectivities.

FIG. 6 illustrates different room layouts for a typical UGR calculation.

FIG. 7A illustrates an embodiment of a deglaring film including an array of microprism elements used to reduce glare in illumination systems of the present teaching.

FIG. 7B illustrates an embodiment of a deglaring film of FIG. 7A in an illumination system configuration of the present teaching.

FIG. 7C illustrates embodiments of prism cross sections of the present teaching.

FIG. 8 illustrates charts plotting modelled output light distributions for the deglaring film of FIG. 7A.

FIG. 9 illustrates charts plotting modelled output light distributions for the machine direction (MD) and the transverse direction (TD) optical intensity distributions for an embodiment of a light transmissive deglaring film of the present teaching having microprisms aligned in the machine direction (MD) for microprisms with a refractive index n˜1.5, having apex angles of 95, 110 and 125 degrees.

FIG. 10 illustrates a chart plotting the higher of the MD and TD UGR values as a function of prism apex angle for an embodiment of a deglaring film having prisms (n˜1.5) aligned in the MD direction of the present teaching.

FIG. 11 illustrates a chart plotting the higher of the MD and TD UGR values as a function of apex angle for an embodiment of a deglaring film having hex-packed cones (n˜1.5) of the present teaching.

FIG. 12 illustrates a chart plotting a maximum UGR for embodiments of deglaring films of the present teaching having a prism with an apex angle of 107 degrees as a function of alignment of the apex direction relative to MD direction.

FIG. 13 illustrates a chart plotting the higher of the MD and TD UGR values as a function of apex angle for embodiments of deglaring films of the present teaching having prisms (n˜1.5) aligned at 45 degrees with respect to MD and TD directions.

FIG. 14 illustrates a schematic of an embodiment of a pattern of small regions with alternating prism apex directions oriented at plus or minus forty-five degrees.

FIG. 15A illustrates plots of the maximum UGR for cones as a function of Apex angle for three different refractive indices (1.5, 1.57 and 1.65).

FIG. 15B illustrates plots of the optimal UGR (lowest maximum value) as a function of refractive index.

FIG. 15C illustrates data showing a maximum UGR for embodiments of deglaring films of the present teaching for prisms oriented at 45 degrees as a function of apex angle for three different values of refractive index of the film.

### DESCRIPTION OF VARIOUS EMBODIMENTS

The present teaching will now be described in more detail with reference to exemplary embodiments thereof as shown in the accompanying drawings. While the present teaching is described in conjunction with various embodiments and examples, it is not intended that the present teachings be limited to such embodiments. On the contrary, the present teaching encompasses various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teaching can be performed in any order and/or simultaneously as long as the teaching remains operable. Furthermore, it should be understood that the apparatus and methods of the present teachings can include any number or all of the described embodiments as long as the teaching remains operable.

When an element is referred to as being on, coupled or connected to/with another element, it can be directly on, coupled or connected to/with the other element or intervening elements may also be present. In contrast, if an element is referred to as being directly on, coupled or connected to/with another element, then no other intervening elements are present. As used herein, the term “and/or” includes any and all combinations of one or more of the associated listed items. The symbol “/” is also used as a shorthand notation for “and/or”.

It will be understood that although the terms first and second are used herein to describe various regions, layers and/or sections, these regions, layers and/or sections should not be limited by these terms. These terms are only used to distinguish one region, layer or section from another region, layer or section. Thus, a first region, layer or section discussed above could be termed a second region, layer or section, and similarly, a second region, layer or section could be termed a first region, layer or section without departing from the teachings of the present invention. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” “includes” and/or “including”, “have” and/or “having” (and variants thereof) when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Illumination systems are needed for applications including room lighting, outdoor lighting, inspection, photography, videography, microscopy and numerous other applications. The light distribution from an illumination system has impact on task performance, appearance, aesthetics, human wellness and mood, special effects and numerous other factors. A feature of the present teaching is the recognition that it is possible to control the light distribution from common light sources using films with surface microstructures having various shapes, sizes, orientations and other characteristics. The microstructures can be formed with apexes having particular apex angles and apex directions that transform input light having one angular light distribution to output light having a different, more desirable, tailored angular light distribution. The output angular light distribution can be tailored, for example, to a particular application, task and/or standard for particular lighting systems.

Using microstructures with the appropriate shape and pattern allows tailoring of the output light distribution in more than one direction or dimension, which is important for many lighting applications. The output angular light distribution can be tailored, for example, to reduce glare in one direction. Also, the output angular light distribution can be tailored, for example, to reduce glare in two different directions. The two separate directions can be orthogonal directions. Reducing glare in more than one direction can be referred to as two-dimensional glare reduction. Reducing glare in more than one direction can be useful in various applications including, for example, room lighting.

As an example, output light distributions can be tailored to reduce glare by reducing output at high angles away from the nadir. The input light distribution from known light sources can have significant light emission at high angles, and the transformed output light distribution of films, referred to herein as a deglaring film, can have much lower light emission at high angles resulting in reduced glare. The light reduction at high angles depends on one or more of an apex angle of the microstructures, an apex direction of the microstructures, a refractive index of the microstructures, and a two-dimensional pattern of the microstructures on a surface of the film.

Known diffuser films having prism structures with apex angles of 90 degrees can transform output light distributions of Lambertian input light, but they suffer from output light in the transformed light distribution at high angles greater than 65 degrees. As such, known microstructure diffuser films suffer from high glare. However, films of the present teaching having a larger apex angle of the prisms as compared to known microstructure diffuser films have reduced high-angle light output, thereby improving the output distribution and reducing glare. In addition to reducing glare and/or enhancing brightness and/or improving uniformity (for example, improving uniformity at low output angles) of output light distributions in various illumination systems, microstructure films of the present teaching can also be configured to be easy to manufacture with reduced cost and be made for ease of integration into an illumination system.

Light distribution from illumination systems is frequently described using polar coordinates. Herein, the term “high-angle luminous intensity” will refer to luminous intensity at polar angles between 65 and about 90 degrees relative to nadir. Herein, the term “axial luminous intensity” will refer to luminous intensity at the polar angle of about 0 degrees. For most downward-facing lighting fixtures, the axial direction is straight down and synonymous with the term nadir. The azimuthal plane is a plane orthogonal to nadir and measures azimuth angles from a reference direction.

A downward-facing light source with Lambertian light distribution has luminous intensity that is proportional to the cosine of the angle from nadir (the downward-facing direction). By definition, the Full Width at Half Maximum (FWHM) of a Lambertian distribution is 120 degrees. In the lighting industry, the term “Lambertian” is also frequently used to refer to light distributions with similar quality but of different widths. That is, distributions that have a peak at nadir, and monotonically decrease at higher angles are often called Lambertian. In one example, a Gaussian distribution with FWHM of 80 degrees will often be called “Lambertian” in the lighting industry.

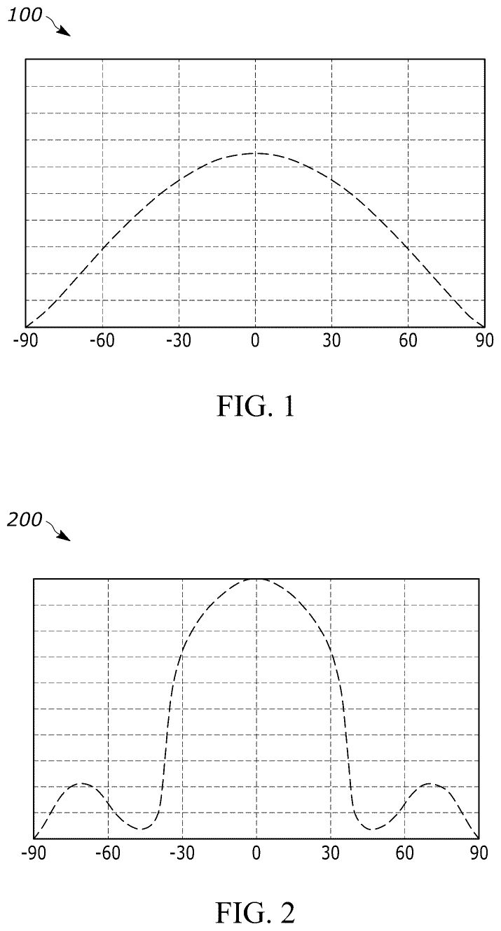

FIG. 1 illustrates a chart 100 showing a Lambertian intensity distribution with a Full Width Half Maximum (FWHM) of 120 degrees. FIG. 1 is based on a measurement of a wide, approximately Lambertian, light source. It can be seen that the high-angle luminous intensity is high, with luminous intensity at 65 degrees approximately 37.5% of the peak luminous intensity.

It is desirable to have illumination systems that can direct light to where it is needed for the particular lighting application while also reducing light distribution in directions where it is not needed or where it can become a problem. In some countries, specifications or recommendations set a limit on the amount of light in the 65 to 90 degree range from nadir that luminaires can emit. Luminaire is a term that refers to lighting fixtures. In the United States, for example, ANSI/IESNA RP-1-04 recommends maximum limits for the luminous intensity emitted at angles above 65, 75, and 85 degrees (at any azimuthal angle). In Europe, EN-12464 places similar limits on luminance at high angles. One feature of films according to the present teaching is that they provide reduced light intensity at high angles from the nadir. For example, in some film embodiments, there is a reduction of light at some angles in angular range between 65 and 90 degrees from nadir. Such performance can help produce lighting systems that meet the standards described in ANSI/IESNA RP-1-04 and EN-12464.

In addition to specific standards, specifications, or recommendations, in some cases lighting designers prefer luminaires with limited high-angle luminous intensity. In some cases, limited high-angle luminous intensity is desirable along one azimuthal plane (e.g. East-West) while not being required in the orthogonal plane (e.g. North-South). In many other cases limited high-angle luminous intensity is desirable in all azimuthal planes. One feature of the present teaching is the realization that it is important to have control over the reduction of high-angle illumination in more than one dimension.

Illumination systems that use high-efficiency LEDs can have a different distribution pattern than those that use traditional bulb-type lamps. However, many known LED light sources exhibit Lambertian distributions. Luminaires using LED light sources can employ various films to help create an illumination pattern with a flatter intensity at angles near nadir, but these films for flat distributions can cause artifacts, especially at high angles. The increased axial luminous intensity of such a light source can most effectively light the space below the luminaire, but can also include artifacts at high angles, such as a wink, which is a bright band of light produced at some high angles along some or all azimuth angles. The wink can be highly undesirable in some applications.

Typical LED light sources emit light into a Lambertian distribution with a Full Width Half Max (FWHM) of approximately 120 degrees. Although LEDs with many other light distributions are available, many cost-effective LEDs sold for general lighting are of the 120-degree Lambertian variety. Many luminaires (LED and traditional) have flat outer surfaces (such as some downlights, task lights, and troffers). In many cases, light emitted by these fixtures has high-angle luminous intensity that is undesirably high. This is often true for luminaires employing other types of light sources in addition to LEDs, such as incandescent lamps, fluorescent lamps, organic light-emitting diodes (OLEDs), etc. In many of these fixtures, a simple flat diffuser (such as a microstructured, holographic, or volumetric diffuser) is used to diffuse the LEDs, hiding their appearance from viewers and smoothing the surface appearance of the luminaire. In the absence of other features such as baffles, louvers, focusing reflectors, focusing refractors, and bezels, these diffusers often give Lambertian distributions of various widths (most typically about 80 to 120 degrees). In such cases, the high-angle luminous intensity may be undesirably high.

Prism optics can be used to improve the light distribution from light sources. For example, a 90-degree linear prism optic has one smooth surface and the other one is textured by an array of parallel linear prisms with 45-degree sidewalls. This is shown, for example, in U.S. Pat. Nos. 2,474,317 and 3,288,990, in which one or two layers of prism optics are used to increase brightness directly under a luminaire, and reduce high-angle luminous intensity. A film with similar properties is also described by Cobb in U.S. Pat. No. 4,906,070. Films such as described by Cobb, usually employing prisms with peak angle of substantially 90 degrees, are used extensively for brightness enhancement of the back light unit inside a display system.

In both lighting and displays, a brightness-enhancing prism is used with the light entering smooth surface of the optic, and thus the prisms face away from the light source. Rays incident perpendicular to the surface of the film will encounter total internal reflections (TIR) from the prisms. Those light rays are generally reflected back into the backlight, which is generally configured with high reflectivity to recirculate those rays back toward the prism film (sometimes repeatedly), until they enter the prism film at larger incident angle and are allowed to pass to the viewer of display. Rays incident at larger angles are at least in part refracted through the prisms, and on average over all angles, the average exit angles are smaller than the average entrance angles, when measured relative to the normal to the prism optic. The angle bending and recirculation process caused by prism films creates a narrower FWHM light distribution (approximately 70-95 degrees) than the incident Lambertian distribution (approximately 120 degrees), and axial brightness enhancement. Said another way, a prism illuminated by Lambertian light in this orientation and with appropriate recirculation will increase axial luminous intensity, while reducing the FWHM.

Luminaires with prism films are films with microstructures having a prism shape at some polar angles between about 65 and about 90 degrees. In these films, luminous intensity is decreased, but most known films that use prisms having 90-degree apex angles also produce a distinct bright band (sometimes called a “wink”) at some polar angles above about 65 degrees at some azimuthal angles. This wink can produce high-angle luminous intensity that is unacceptably high. These known prism films can exhibit unacceptable glare in one or more directions. FIG. 2 illustrates a chart 200 showing the light distribution of a Lambertian light source after passing through a linear prism film. This chart is from a measured 90-degree prism film illuminated by an approximately Lambertian source in which the measured azimuthal plane was perpendicular to the major direction of the linear prisms. The plot is for a slice that is perpendicular to the linear prism orientation. The “wink” is caused by the peaks noticeable at approximately +/−70 degrees.

The wink artifact, and the light paths within a prism optic that lead to the wink, are described, for example, by Richard et al. in U.S. Pat. No. 7,777,832. Having no wink is defined herein by having a light distribution that substantially monotonically decreases as polar angles increase from the angle of peak luminous intensity. Richard et al. describe incorporating diffusion into a linear prism film to make the wink less noticeable in displays, using what is essentially a blurring process. This process may leave too much high-angle luminous intensity for use in lighting applications. Thus, it may be desirable to simultaneously have substantially no wink or minimized wink and have low high-angle luminous intensity. In many cases it is desirable to increase the axial luminous intensity of a light source, that is the amount of light emitted along the nadir, so as to most effectively light the space below the luminaire. In many of these cases, it is desirable to do so without artifacts at high angles such as a wink that can be caused by known 90-degree prism films.

Surface structured films that include cones are also known in the art to reduce high-angle luminous intensity of a light source. Such use of cone shapes is mentioned in U.S. Pat. Nos. 2,474,317, 3,349,238, 3,159,352, 3,483,366, U.S. Patent Application Publication No. 2013/0057137, U.S. Patent Application Publication No. 2010/0128351 and German Patent Application No. DE102006009325A1. A cone-like hexagonal pyramid is described in German Patent No. DE202010002744U1. In U.S. Pat. No. 7,631,980 and International Publication No. WO 2005/083317A1, a cone with inverted tip is pictured that resembles a prism bent into a single ring.

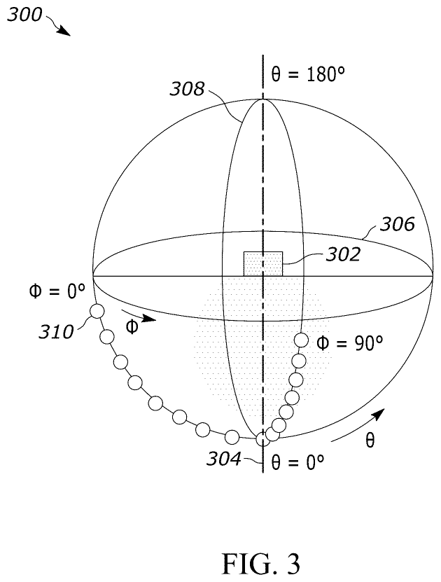

FIG. 3 illustrates a configuration of a known goniometric apparatus 300 used to measure the light distribution from a luminaire. Light distributions are typically measured using such a goniometric apparatus 300 as described, for example, in the IES LM-79 standard. A luminaire 302, or illuminated optical device, is depicted emitting light in a downward dimension. The θ=0° direction 304 illustrated is the same as nadir. The two circles with dots on their perimeters represent planes 306, 308 at two different azimuthal angles φ (phi). In each of these planes 306, 308, the polar angle θ (theta, ranging from −180 to 180 degrees) is defined as indicated. Example measurement points in the phi=0 degree and phi=90 degree planes are depicted as circles 310. At each of these measurement points, luminous intensity is measured as a function of the theta angle from the principle axis (θ=0°, or nadir) of the light source. This luminous intensity is measured by an optical detector; the optical detector and/or light source may be moved relative to each other so that the optical detector measures light at the desired angles. In practice a light source can be measured at any group of phi and theta points desired. Many lights emit generally in one hemisphere, and thus theta will often be measured from −90 to 90 degrees.

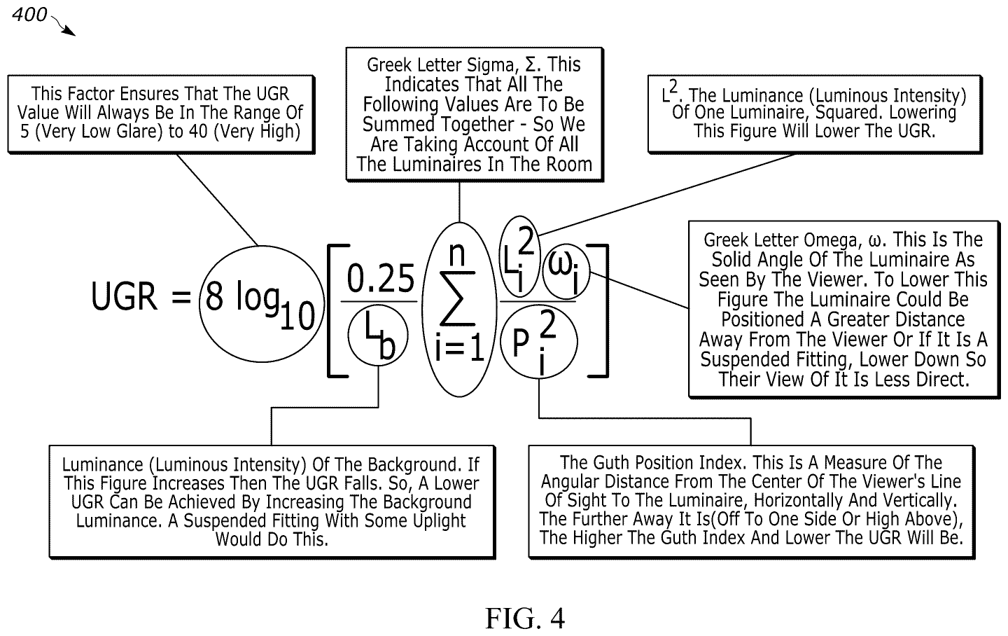

Glare from illumination systems is characterized by the Unified Glare Rating (UGR). The UGR is calculated using a formula shown in FIG. 4. See, for example, https://www.nvcuk.com/technical-support/view/what-is-ugr-18. FIG. 4 illustrates an equation for a unified glare rating (UGR) that highlights the key contributions to glare ratings for illumination systems.

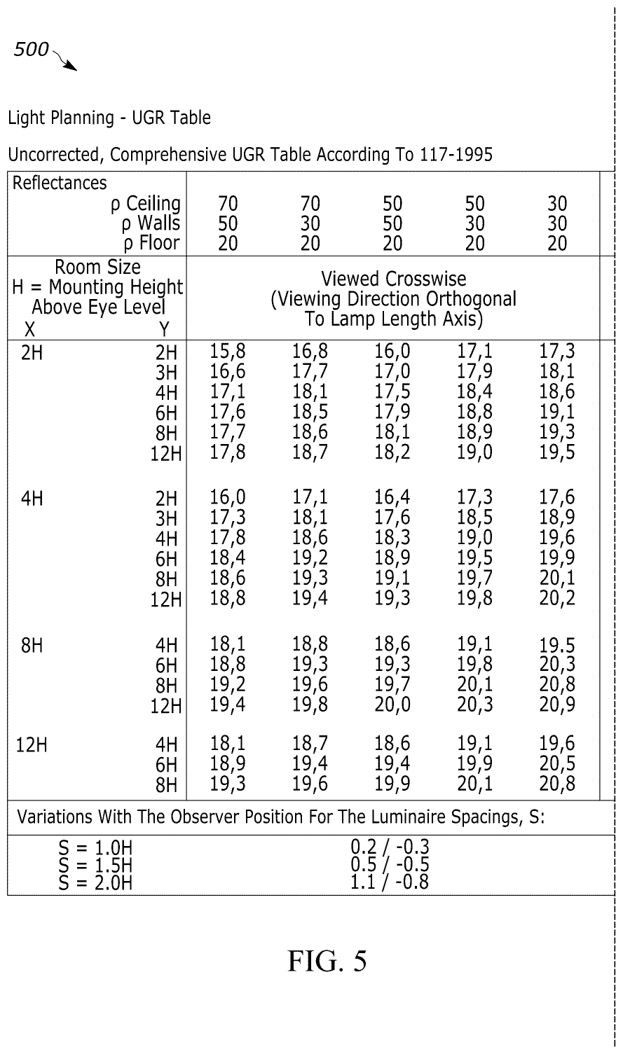

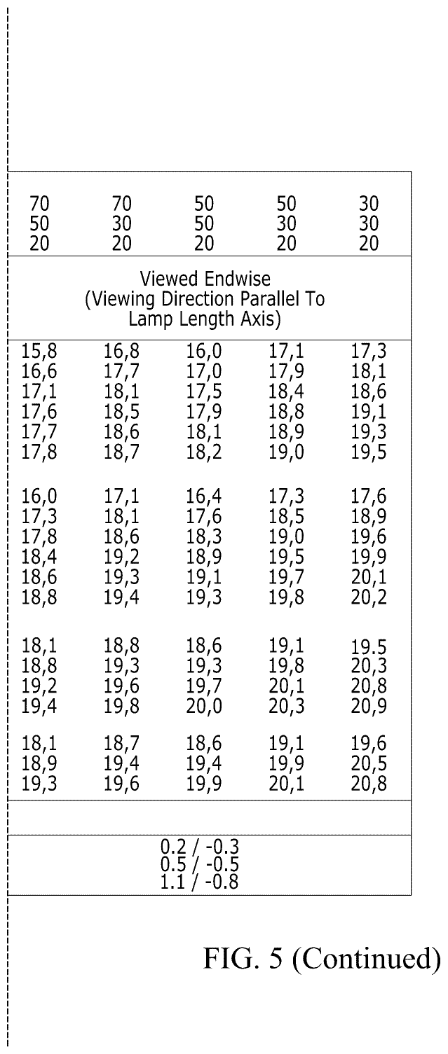

The lower the calculated UGR number the better the performance. In other words, the lower the calculated UGR, the lower the glare level. The calculation can be complicated because it depends on several factors, including the number of luminaires in a room, the size of the room (height, width and length), the reflectivity of room surfaces and the angular distribution of the light intensity of each luminaire. Often, when measuring an individual luminaire, the data will be reported as a table. FIG. 5 illustrates a table 500 showing UGR data for an individual light with 190 values corresponding to different room sizes and surface reflectivities. As seen in the table 500 FIG. 5, one hundred ninety different values correspond to different room sizes and surface reflectivities.

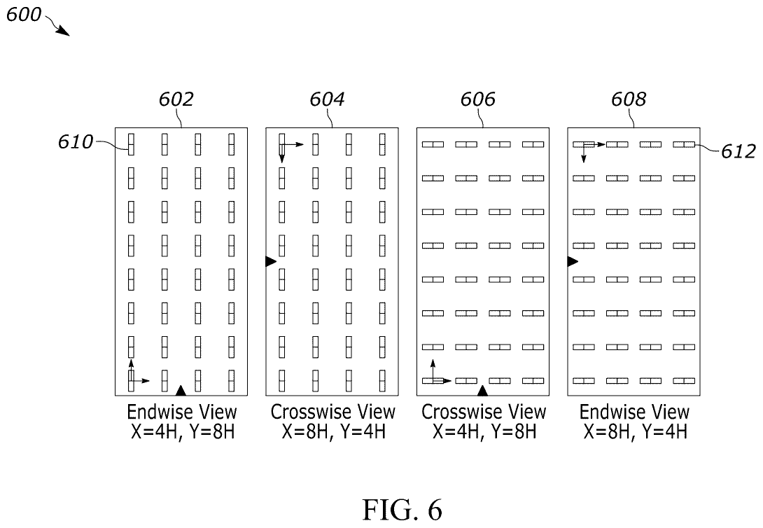

For the sake of simplicity, we will use just two UGR values for modeling. Machine direction (MD) and transverse direction (TD) are orthogonal directions. The two UGR values modelled are UGR MD and UGR TD, where MD refers to endwise and TD refers to crosswise. For modelling, the output light distributions from films are measured in these two directions, MD and TD. Other assumptions include a room size of X=4H, and Y=8H with ceiling, wall and floor reflectivities of 70, 50 and 20% respectively and light spacing-to-height ratio are assumed. The light output is assumed to be 3000 lumens and an area of 0.306 square meters. FIG. 6 illustrates different room layouts 600 for a typical UGR calculation. A couple of important points are shown in FIG. 6. Rooms 602, 604, 606, 608 are typically rectangular in shape (which includes a square shape). Light fixtures 610, 612 are also often rectangular in shape. The major axis of the light fixtures 610, 612 are typically aligned with one of the major axes of a room 602, 604, 606, 608. Also, the UGR calculation takes into account light coming from fixtures at all angles.

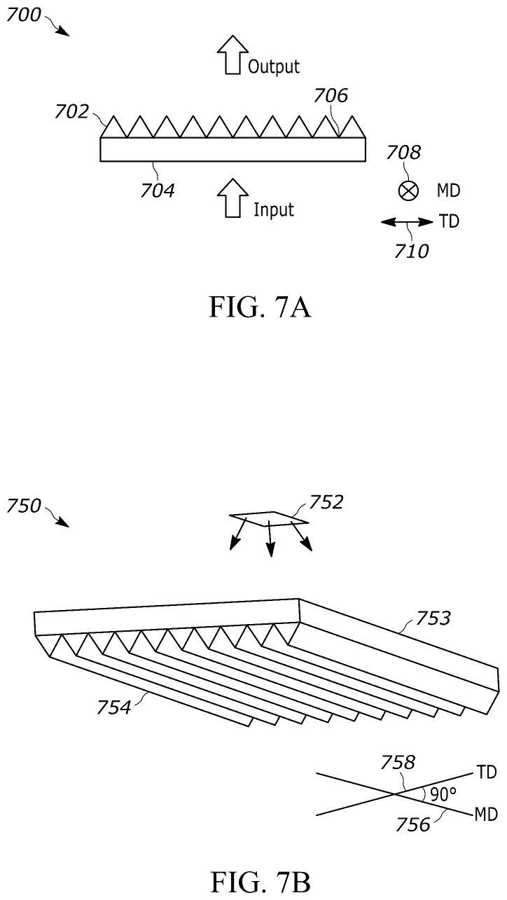

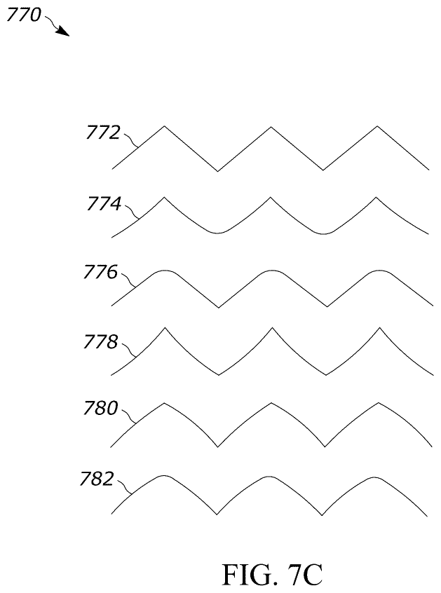

As described herein, films that include arrays of parallel microprisms on at least one side can be used to produce desired light output distributions from luminaire that use lamps or LEDs having a nominally Lambertian light output distribution. FIG. 7A illustrates an embodiment of a deglaring film 700 including an array of microprism elements 702 used to reduce glare in illumination systems of the present teaching. The figure shows an enlarged fragmentary perspective view. A first surface of the film 700 is nominally smooth. A microprism 702 positioned on a second surface has a generally triangular cross section with sides defining a peak, the cross section taken in a plane perpendicular to the second surface of the substrate. The peak may be generally parallel to the second surface of the substrate. Other shapes can be used. It is possible to model the UGR for an output distribution of this deglaring film 700 and a Lambertian input distribution incident on the first surface of the film. The microprism elements have 90-degree apex angles. In various embodiments, the apex angles of the microprisms take on different values than 90 degrees. The refractive index of the microprism elements 702 is assumed to be 1.5 for the model, but higher refractive indices can also be used. For the illumination model, the input surface 704 is the first surface with no microstructures, and the output surface 706 is the second surface that has the microstructures.

For the embodiment of deglaring film 700 of FIG. 7A, the apex direction of the microprisms is oriented along the machine direction. As such, the MD direction 708 is into and out of the page, and the TD 710 direction is orthogonal to the MD direction. One significance of the MD and TD directions relates to how the films are manufactured and cut for use in an illumination system. In addition, as mentioned earlier, for modeling the output light distributions are measured at various angles relative to the MD direction and the TD direction. Thus, the alignment of the apex direction of microstructures to one or the other of the MD and TD directions on the film also indicates a relative alignment to the respective MD or TD measurement directions for the output distribution from the illumination system.

FIG. 7B illustrates an embodiment of a deglaring film 700 of FIG. 7A in an illumination system 750 configuration of the present teaching. The illumination system 750 is typically oriented so as to produce light from above. A light source 752 produces light in a nominal Lambertian distribution to an input surface of a film 753 that is, for example, the deglaring film 700 described in connection with the description of FIG. 7A. The prism apexes 754 are positioned on a second surface of the film 753 and point away from the light source 752 toward the output side of the illumination system 750. The apex direction of the prism microstructures is oriented along the MD direction 756 of the roll of film. The TD direction 758 is orthogonal to the MD direction. In embodiments that comprise a luminaire fixture, the prism apex direction can be oriented with respect to one of the major axes of the luminaire. In addition, the prism apex direction can be oriented at 45 degrees with respect to a light fixture axis (X and Y). The X and Y of the lighting fixture can be oriented parallel or perpendicular to the office orientation. For example, the orientation of an office cube arrangement grid. This alignment is advantageous because steep angle light in these directions is more likely to bounce off of a display.

FIG. 7C illustrates embodiments of prism cross sections 770 of the present teaching. In general, there are nearly limitless ways in which a prism can be modified in cross-sectional shape. It is understood that the prism cross sections 770 in the figure represent prisms composed of a transparent material, and that relative to the drawings, a substrate of a film is understood to be below the prisms. The cross sections shown are examples and not intended to limit the possible shapes of prism cross sections of the present teaching. The first prism cross section 772 depicts an isosceles-triangular prism. The second prism cross section 774 depicts a prism with rounded valleys, that is, the part of the prisms that is closest to the substrate is rounded. The third prism cross section 776 depicts prisms with rounded peaks, that is, the part of the prisms that extends farthest away from to the substrate. The fourth prism cross section 778 depicts prisms with sides that are concave when viewed from above. The fifth prism cross section 780 depicts prisms with sides that are convex when viewed from above. Combinations of these cross sections and other modifications are possible. For example, the sixth prism cross section 782 depicts prisms that have rounded peaks and convex sides. According to laboratory experiments by the Applicant, prisms with rounded peaks and convex sides such as depicted in the sixth cross section 782 can provide improved effectiveness in reducing high-angle luminous intensity compared to the other cross sections depicted. In addition, in practice, slight rounding of prism peaks and valleys can be unavoidable in many manufacturing processes. Thus, the recognition that it is possible to reduce high-angle illumination using deglaring films that have prism microstructure cross sections with rounded peaks and/or valleys can lead to more cost effective solutions. The apex angle of these modified prisms can be poorly defined and when we are referring to an apex angle for a non-perfect prism, we are defining the apex angle to be equal to 180 degrees minus the sum of the average of the two prism facet angles relative to the substrate plain. For example, a 90-degree apex angle would have the sum of the two average prism facet angles equal to 90 degrees. For example, a 100-degree apex angle would have the sum of the two average prism facet angles equal to 80 degrees.

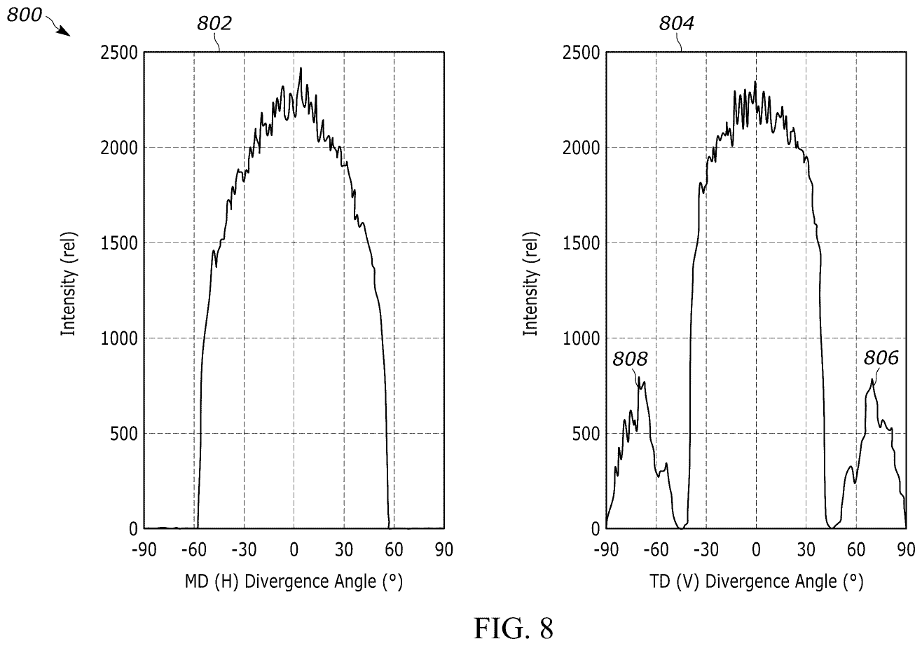

FIG. 8 illustrates graphs 800 showing modelled output light distributions for the deglaring film described in connection with FIGS. 7A-B. Referring to both FIG. 7A and FIG. 8, for the model, the deglaring film 700 including an array of 90-degree-apex microprism elements 702 was positioned at an exit surface under a Lambertian light source. The apexes of the microprism elements were oriented in the endwise (that is, MD) direction. The graph 802 shows the intensity at the output of the deglaring film as a function of divergence angle in the MD direction when illuminated from above by a Lambertian input distribution. The graph 804 shows the intensity as a function of divergence angle in the TD (crosswise) direction. From the graph 804, in the TD direction the light distribution exhibits relatively high secondary peaks 806, 808 at an angular position of ˜+−75 degrees. Such a light distribution would be expected to result in high glare. In contrast, the light intensity in the MD direction shown in graph 802 drops off sharply with angle, corresponding to low glare. Calculating the UGR for this illumination system results in a very high value of 23.7 for UGR TD 0.25 and a lower value of 13.7 for UGR MD 0.25.

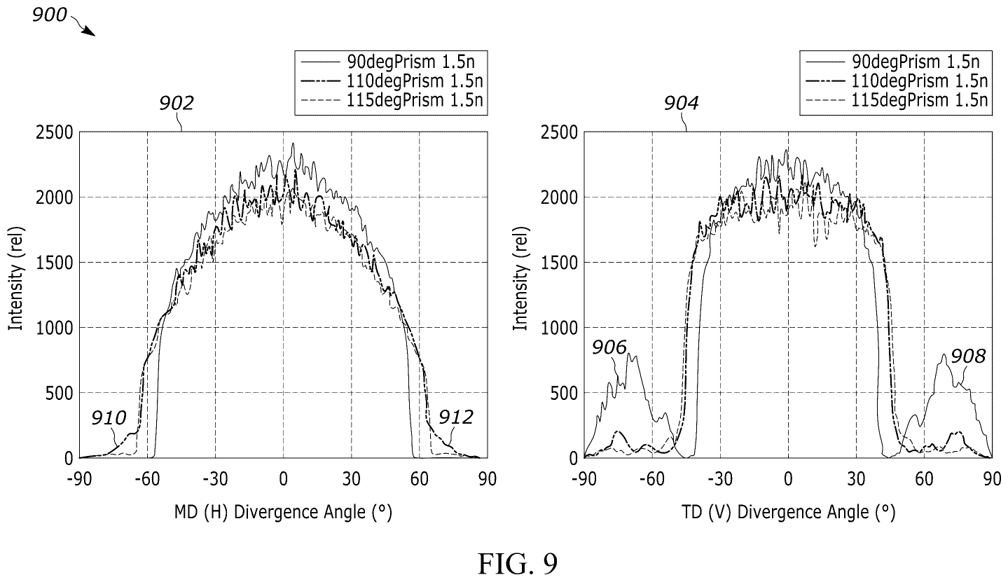

FIG. 9 illustrates charts 900 plotting modelled output light distributions for the MD and TD optical intensity distributions for an embodiment of a light transmissive film of the present teaching having microprisms aligned in the machine direction (MD) for microprisms with apex angles of 95, 110 and 125 degrees. The refractive index is nominally n=1.5. One chart 902 plots the light distribution in the machine direction MD for an embodiment having microprisms aligned along the machine direction, and the other chart 904 plots the light distribution in the transverse direction for an embodiment having microprisms aligned along the machine direction. When the apexes are aligned along the MD direction, light in the TD direction is produced at high angles, as shown at high-angle points 906, 908 over 60-degrees in the chart 904. In contrast, light output at high angles is considerably lower in the MD oriented apex directions modelled in chart 902, particularly for 90-degree apex angle microprisms. It can be seen from the plots in chart 904 that, for the TD direction as the apex angle increases, the high-angle secondary peaks that causes winks become smaller. This improves the TD UGR. This is in contrast to the light distribution in the machine direction shown in the chart 902 for films having apexes oriented in the MD direction. In this case, the increasing apex angle increases the glare at higher angles. This is evident from the light intensity at high-angle regions 910, 912 in chart 902 for apex angles of 110 degrees and 115 degrees.

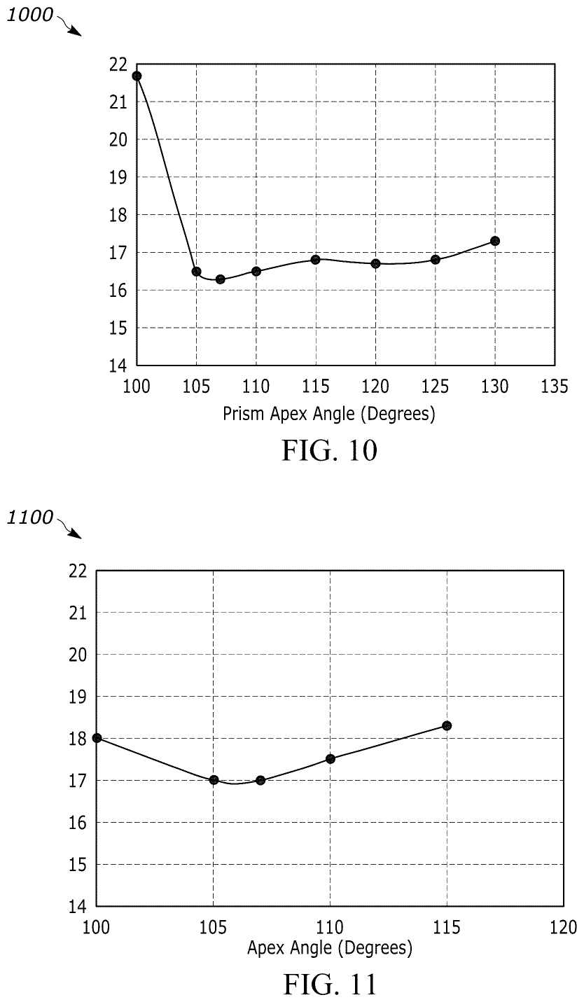

FIG. 10 illustrates a chart plotting the higher of the MD and TD UGR values as a function of prism apex angle for an embodiment of a deglaring film having prisms aligned in the MD direction of the present teaching. The refractive index is nominally n=1.5. The higher of the MD and TD UGR values is plotted in in the chart 1000 as a function of prism apex angle for prisms aligned in the MD direction. It can be seen that the lowest UGR (that is the maximum of the MD and TD values) occurs at a prism apex angle of about 105 to 110 degrees. These prism apex angles provide a UGR that is less than 17. As such, some embodiments of the present teaching utilize deglaring films having parallel prism microstructures with apex angles in a range from 105 degrees to 110 degrees. This configuration ensures that whether the apex direction is oriented in the MD or TD direction of the output light, a minimal value of glare is ensured. This is an example of a film of the present teaching that advantageously reduces glare in two dimensions because of the choice of apex angle of the microstructures and the orientation of the apexes on the film. Apex angles other than those between 105 and 110 degrees can also be used.

One feature of the deglaring films of the present teaching is that they can use cone-shaped microstructures rather than parallel microprisms.

FIG. 11 illustrates a chart 1100 plotting the higher of the MD and TD UGR values as a function of apex angle for an embodiment of a deglaring film having hex-packed cones of the present teaching. The refractive index of the cones is nominally n=1.5. Cones are known in the art to be a surface structure that can reduce high-angle luminous intensity of a light source. Such use of cone shapes is mentioned in U.S. Pat. No. 2,474,317. The higher of the MD and TD UGR values is plotted as a function of apex angle for hex packed cones in the chart 1100. Interestingly the optimal cone apex angle is very similar to the optimum apex angle for prisms oriented in the MD direction with a minimum UGR of approximately 17.

Thus, embodiments of deglaring films of the present teaching that utilize hex packed cones with apex angles of 105 degrees through 110 degrees can provide UGR of below 18. Embodiments of deglaring films according to the present teaching that utilize hex packed cones with an apex angle of 105 degrees provides a UGR of 17. Surprisingly for simple aligned prisms with an apex angle of 105 degrees the UGR is significantly lower at 16.3. Thus, some embodiments of deglaring films of the present teaching utilize simple aligned prisms with apex angles between 105 degrees and 115 degrees to provide a UGR less than 17. It is important to remember that UGR values are logarithmic. Some embodiments of the present teaching utilize deglaring films having hex-packed cone-shaped microstructures with apex angles in a range from 105 degrees to 110 degrees and provide UGR of between 17 and 18.5. However, other apex angles can also be used as set by the desired value of UGR for the application. One feature of the present teaching is the recognition that the apex angle of microstructures can be chosen to provide different values of UGR, which allows the deglaring films to be engineered and manufactured to cost effectively meet particular illumination goals, including reduction of glare and providing illumination distributions with particular desired UGR values.

One feature of the present teaching is that it is possible to align the apex direction of parallel microprisms at a particular angle, or range of angles, relative to the machine direction of the film manufacture and in turn it is possible to align the apex direction of the parallel microprisms at a particular angle, or range of angles, relative to one of the major axes of a luminaire. In U.S. Pat. No. 10,317,583, which utilizes a distribution of prisms at all angles relative to the MD direction, it states “[v]arious embodiments described herein are based on the surprising insight that in practice, prisms on substantially parallel curvilinear paths representing substantially all orientation angles may provide equivalent or better reduction of high-angle luminous intensity than collections of straight linear prisms tiled in zones with a limited number (such 1, 2, 3 or 4) of prism orientation angles.” This statement raises the question of whether there are some prism alignment angles which result in reduced glare.

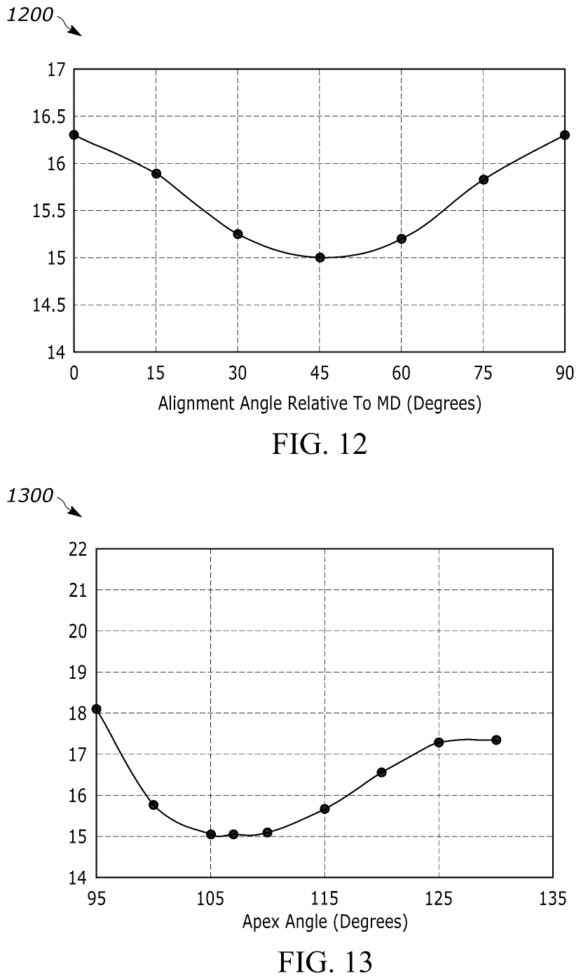

It is possible to calculate the UGR values for prisms aligned at different angles relative to the machine direction. FIG. 12 illustrates a chart 1200 plotting a maximum UGR for embodiments of deglaring films of the present teaching having a prism with an apex angle of 107 degrees as a function of alignment of the apex direction relative to MD direction. It can be seen from the chart 1200 that the lowest maximum UGR values are achieved when the prism is aligned at 45 degrees relative to the MD direction. Alternatively, −45-degree alignment would be similar. In fact, the attainable max UGR is reduced by more than 1.0. Because this is a logarithmic scale this is a substantial reduction. From the chart 1200 it can see there is still substantial UGR reduction for alignment angles of +−15 degrees on either side of 45 degrees. Thus, some embodiments of the present teaching utilize deglaring films having parallel microprisms with apex directions oriented in a range between 30 degrees and 60 degrees relative to the machine direction. Other relative directions can also be used.

FIG. 13 illustrates a chart 1300 plotting the higher of the MD and TD UGR values as a function of apex angle for embodiments of deglaring films of the present teaching having prisms aligned at 45 degrees with respect to MD and TD directions. It can be seen from the chart 1300 that the best UGR is achieved for an apex angle between 100 and 117 degrees with the best UGR for an apex angle of approximately 107 degrees. Some embodiments of illumination systems of the present teaching utilize deglaring films having parallel prism microstructures with apex angles in a range from 100 degrees to 117 degrees and the apex direction aligned at 45 degrees relative to the MD and TD directions. Other apex angles beyond this range can also be used.

One feature of the present teaching is that deglaring films that include microstructures positioned on at least one side of the film can provide various desired output light distributions. In some embodiments, the deglaring film is configured to reduce luminous intensity of the light emerging from the second surface at angles greater than about 65 degrees from a direction orthogonal to the light transmissive substrate to less than about 30% of the light emerging from the second surface in the direction orthogonal to the light transmissive substrate. In various embodiments, the deglaring film may be configured to reduce luminous intensity of the light emerging from the second surface at angles greater than about 65 degrees from the direction orthogonal to the light transmissive substrate to less than about 20% or less than about 15% of the light emerging from the second surface in the direction orthogonal to the light transmissive substrate. The deglaring film may be configured to monotonically decrease luminous intensity of the light emerging from the second surface at increasing angles from the direction orthogonal to the light transmissive substrate.

In some embodiments, the deglaring film is configured to substantially reduce luminous intensity of the light emerging from the second surface at angles between about 65 degrees and about 85 degrees from a direction orthogonal to the light transmissive substrate relative a Lambertian light distribution. In some embodiments, the deglaring film is configured to substantially increase luminous intensity of the light emerging from the second surface in a direction orthogonal to the light transmissive substrate relative to a Lambertian light distribution. The deglaring film may be configured to increase luminous intensity of the light emerging from the second surface at angles up to at least about 30 degrees from the direction orthogonal to the light transmissive substrate relative to a Lambertian light distribution.

A large majority of light fixtures tend to be square or rectangular in shape, and are typically installed in rooms where the major axis of the lights is aligned with those of the rooms. Thus, it is beneficial to add a film with prisms on the surface facing away from the light source. Some of the best glare performance can be achieved when the prisms have an apex angle between 95 and 117 degrees, with 107 degrees being particularly beneficial. The prisms can be aligned at 45 (within +−15) degrees with respect to one of the major axes of the room and light fixtures.

In order to efficiently utilize a roll of film, the prisms on the surface of the film can be aligned at 45 degrees (+−15 degrees) with respect to the machine direction, otherwise there is significant waste when rectangular shapes with prisms aligned at 45 degrees are cut from the film.

Various embodiments of illumination systems described herein relate to light sources, particularly luminaires, for providing special lighting patterns. These embodiments have particular, but not exclusive, usefulness in providing favorable light distributions with reduced luminous intensity at high angles.

A two-dimensional (2D) deglaring film of the present teaching can include an optic (e.g., a prism optic) that reduces high-angle luminous intensity of a wide light source (e.g., a Lambertian light source) in substantially all azimuthal directions. Various embodiments provide a 2D deglaring film that can reduce high-angle luminous intensity of a light source. In addition, or instead, various embodiments described herein provide a luminaire that can provide reduced high-angle luminous intensity employing a 2D deglaring film. In addition, or instead, various embodiments described herein provide an illumination system that can provide reduced high-angle luminous intensity employing a 2D deglaring film. In addition, or instead, various embodiments described herein describe a method for using a 2D deglaring film that can decrease the luminous intensity emitted by a light source at high angles. In addition, or instead, various embodiments described herein describe a backlight for display or signage employing a 2D deglaring film that can provide reduced high-angle intensity. In addition, or instead, various embodiments described herein provide a 2D deglaring film that can increase axial luminous intensity of a light source and/or can have no wink. In addition, or instead, various embodiments described herein provide a luminaire that can provide increased axial luminous intensity employing a 2D deglaring film and/or can have minimized wink. In addition, or instead, various embodiments described herein provide an illumination system that can provide increased axial luminous intensity and/or minimized wink employing a 2D deglaring film. In addition, or instead, various embodiments described herein describe a method for using a 2D deglaring film that can increase axial luminous intensity to increase the luminous intensity emitted by a light source along its principal axis and/or provides a light distribution with minimized wink.

One feature of the present teaching is that the deglaring films help to obscure light sources in illumination systems for various applications. For example, some embodiments of illumination systems of the present teaching can provide a 2D deglaring film that obscures or helps obscure light sources, including but not limited to LEDs and fluorescent lamps. In addition, or instead, some embodiments described herein can provide a 2D deglaring film that has a visible surface pattern that may be aesthetically pleasing to a viewer. In addition, various embodiments described herein can provide a 2D deglaring film that has a visible surface pattern can visually obscure light sources such as LEDs or distracts the eye to reduce their visibility. In addition, or instead, various embodiments described herein describe a 2D deglaring film with visible surface patterns that can produce a sparkly appearance when illuminated by an array of LEDs.

One feature of the present teaching is that the deglaring films can produce various special lighting effects in illumination systems for various applications. For example, some embodiments described herein describe a 2D deglaring film with visible surface patterns that can produce a sparkly appearance or pattern when illuminated by an array of LEDs, said sparkly pattern appearing to change when viewed from different viewing angles. In addition, or instead, various embodiments described herein describe a method for using a 2D deglaring film that can decrease high-angle luminous intensity and/or increase axial luminous intensity in conjunction with a traditional diffuser to provide a substantially uniformly bright surface. In addition, or instead, various embodiments described herein describe a method for using a 2D deglaring film that can decrease high-angle luminous intensity and/or increase axial luminous intensity in conjunction with a traditional diffuser to provide a substantially uniformly bright surface with surface patterns visible from at least one viewing angle.

One feature of the present teaching is that the deglaring films can produce high optical brightness and/or highly uniform light output in illumination systems for various applications. For example, some embodiments described herein can provide 2D deglaring film with high optical efficiency, having substantially no light-absorbing materials. In addition, or instead, various embodiments described herein can provide a 2D deglaring film that increases the luminance uniformity on the surface of a luminaire.

In addition, or instead, various embodiments described herein can provide a 2D deglaring film than can be efficiently and inexpensively mass-produced in areas large enough to be suitable for use in general lighting. In addition, or instead, various embodiments described herein can provide a substantially flat or slightly curved 2D deglaring film that reduces high-angle luminous intensity.

Various embodiments described herein can provide a 2D deglaring film comprising a substrate having a first and second surface, the first surface being substantially smooth or flat, and the second surface having pattern elements comprising a plurality of substantially parallel prismatic microstructures, or prisms, said prisms and having multiple prism orientation angles of ˜+45 and −45 degrees over the area of the substrate, configured to reduce high-angle luminous intensity relative to a wide Lambertian light distribution for light emitted from the second surface when the first surface is illuminated by a wide Lambertian light distribution. They may also be configured to provide substantially no wink or minimized wink and/or increase axial luminous intensity relative to a wide Lambertian light distribution when similarly illuminated.

The prisms can have a cross-sectional shape that is substantially isosceles triangular or modified triangular and may include features such as a rounded tip and/or valley, a tip resembling a pointed arch tip or Gothic arch and/or ogive, side curvature, surface roughness and/or variation in prism pitch, height, and/or angle. In many embodiments, these shapes form pattern element(s) that are repeated or tiled across the substrate. These tile-shaped regions can be positioned adjacent to each other forming a tile axis directed, for example, along the top of two adjacent regions.

In some embodiments, the triangle approximating the cross-sectional shape of the prisms has an internal angle (apex angle) of between 95 and 120 degrees, and in some embodiments, the apex angle can be between 100 and 120 degrees, and in some other embodiments, the apex angle can be between 100 and 110 degrees. In some embodiments, the cross-sectional shape is in the form of an approximate isosceles triangle with convex slightly curved sides. In some embodiments, the cross-sectional shape additionally has a rounded peak.

Some embodiments of deglaring films of the present teaching have a configuration that is based on the surprising insight that, in practice, prisms on substantially parallel paths at 45 degrees or +45 and −45 degrees can provide better reduction of high-angle luminous intensity than arrays of cones or arrays of cones with inverted tips.

One feature of the present teaching is the recognition that the 2D deglaring film in some embodiments does not require alignment to the light source, other than aligning the prism orientation with respect to the axis of the light fixture. In addition, the deglaring films can be manufactured in large areas, thereby reducing cost. As such, illumination systems including deglaring films of the present teaching can be used to supply low-cost lighting solutions.

One feature of the present teaching is that the microprisms can be configured with various two-dimensional patterns across the surface of the films. For example, deglaring films according to various embodiments described herein include a light transmissive substrate having first and second opposing faces and array of microprism elements on the second surface, with a respective microprism element comprising a plurality of concentric microprisms. The deglaring film is configured to receive light from a light source facing the first surface and reduce high-angle luminous intensity of the light emerging from the second surface.

One feature of the present teaching is the recognition that using a deglaring film with multiple regions of different microstructure shapes and patterns can provide desirable light output patterns. For example, some embodiments of 2D deglaring films include prisms arranged in pattern elements that have a mixture of +45- and −45-degree alignment orientations.

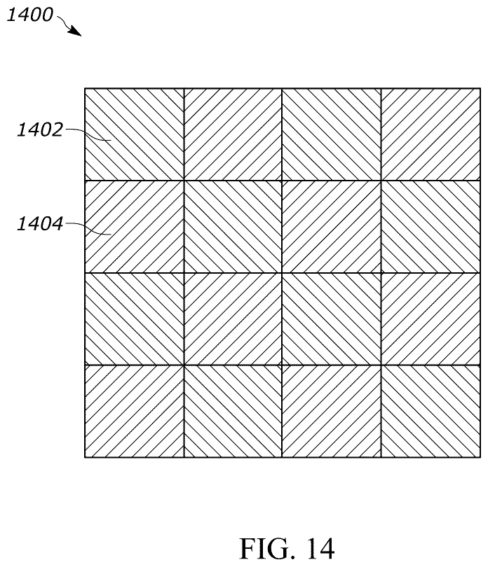

FIG. 14 illustrates a schematic of an embodiment of a pattern of small regions with alternating prism apex directions oriented at plus or minus forty-five degrees. Square regions 1402, 1404 have different patterns of microstructures. The figure illustrates the orientation of the apex directions for parallel arrays of prisms in each region 1402, 1404. A first region 1402 has a +45-degree orientation, and an adjacent region 1404 has a −45-degree orientation. The pattern repeats in what can be referred to as a tiled pattern. A tile axis runs parallel to the tops of adjacent regions in the tile pattern. A surprising insight of the present teaching is the recognition that, in practice, prisms on substantially parallel paths representing an orientation angle of approximately 45 degrees or +45 and −45 degrees may provide better reduction of high-angle luminous intensity than collections of straight linear prisms oriented parallel to one of the axes of a light of collections of prisms with all orientation angles. The use of small regions of prisms oriented at + and −45 degrees can provide advantages, including, for example, increased obscuration of light sources, decreased artifacts at specific azimuthal angles, and/or desirable aesthetic appearance.

It is understood, when referring to FIG. 14, and other figures herein representing prism arrays, that the figures depict one section of the prism array with a finite number of tile elements. The 2D deglaring films of the present teaching may comprise a larger (or smaller) array of prisms than the extent of the array presented in the figures.

The characteristic size of pattern regions for a tiled arrangement of pattern elements can be defined as the distance between each tile, or average distance between nearest-neighbor tiles in the case of non-periodic or irregular tilings.

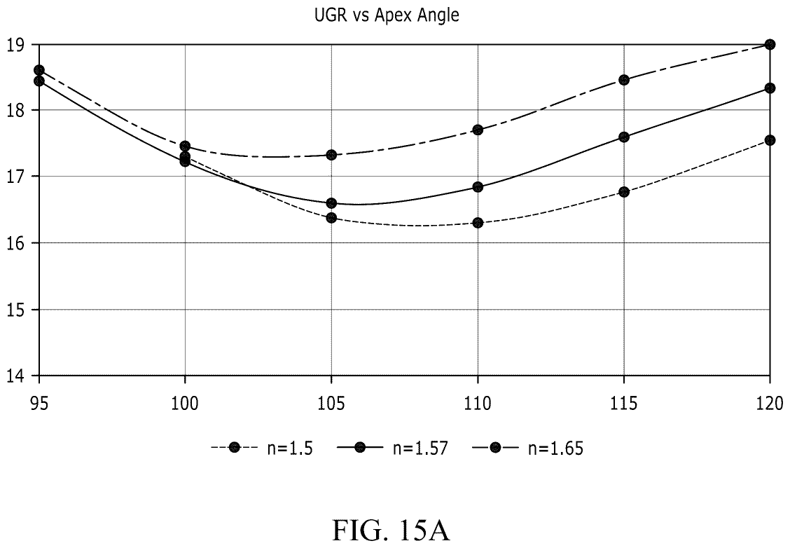

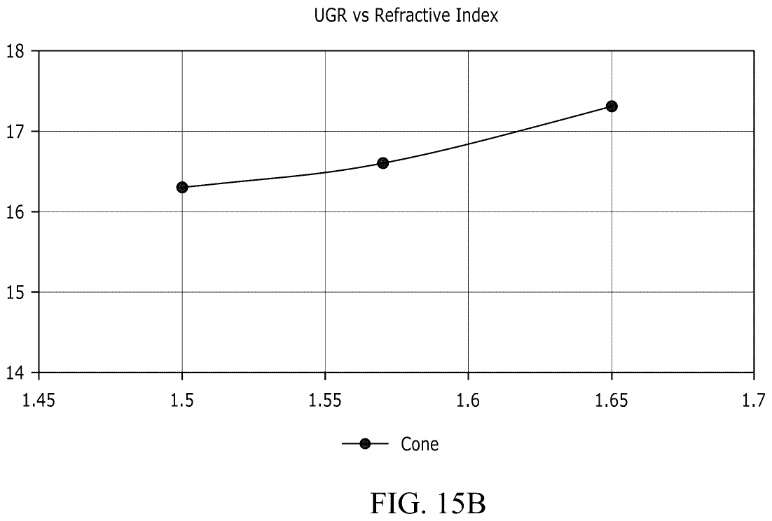

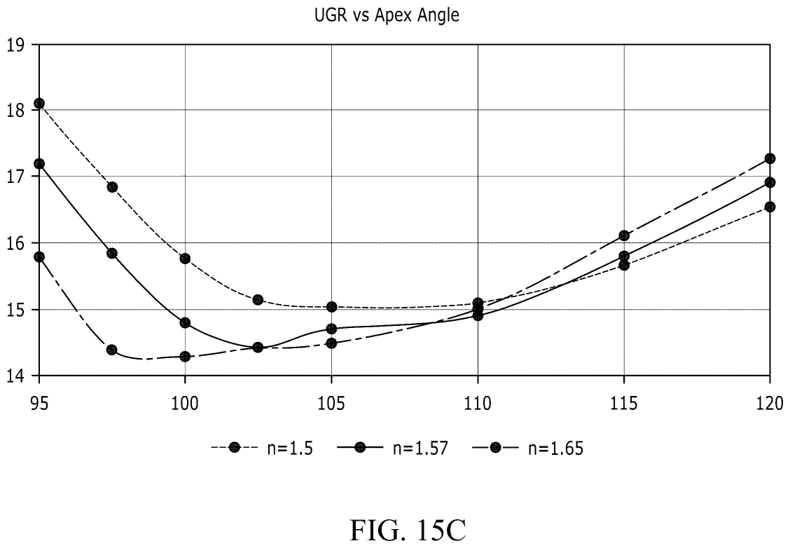

FIG. 15A illustrates plots of the maximum UGR for cones as a function of Apex angle for three different refractive indices (1.5, 1.57 and 1.65). It can be seen that as the refractive index increases the optimum apex angle for best UGR shifts to steeper apex angles, that is, lower values. As the refractive index increases the UGR (at the optimal apex angle) becomes worse. The plots show the UGR for various embodiments of deglaring films according to the present teaching that use different apex angles and refractive indices to provide particular UGR values in a range between sixteen and nineteen. The optimal UGR (lowest maximum value) for these embodiments of deglaring films is plotted in FIG. 15B. FIG. 15B illustrates plots of the optimal UGR (lowest maximum value) as a function of refractive index. The refractive index refers to the value of the layer encompassing the cones or other deglaring structures. If the layer of deglaring structures is on top of a substrate material, the refractive index of the planar substrate can be different and does not significantly impact the UGR value. In general, the refractive index of the deglaring structures in some embodiments, for various apex angles, can be greater than n=1.55. In some embodiments, the refractive index of the deglaring structures, for various apex angles, can be greater than 1.62.

FIG. 15C illustrates data showing a maximum UGR for embodiments of deglaring films of the present teaching for prisms oriented at 45 degrees as a function of apex angle for three different values of refractive index of the film. This plot compares films having prism apex direction oriented at 45 degrees as described herein. It is clear from comparing the plots for prism refractive indices of 1.5, 1.57 and 1.65, that the highest refractive index, which in this example, is a refractive index of 1.65, results in the lowest values of maximum UGR in contrast to the case of cones. It is also clear from comparing the plots that the optimal apex angle, that is the apex angle having the lowest maximum UGR, is shifted to larger angles with decreasing refractive index. That is, the lowest refractive index, in this example n=1.5, has an optimal angle between 105 degrees and 110 degrees, while the largest refractive index, in this example n=1.65, has an optimal angle between about 98 degrees and 100 degrees.

One feature of the present teaching is that the deglaring films can also comprise one or more diffusion features. For example, the diffusion feature can include surface roughness on at least some of the microstructures. The diffusion feature can also or instead include a diffuser on the first surface of the substrate. The diffusion feature can also or instead include a light scattering agent in at least some of the prisms and/or in the substrate of the films. The diffusion feature can also or instead include a diffusive coating on at least some of the microstructures.

The characteristic size of the pattern elements (which, for example, in the case of close-packed square is the spacing between squares) will affect various embodiments described herein as follows: If the characteristic size is very small (smaller than about 1 mm) it will be undetectable by the naked eye of an observer, and the surface of the 2D deglaring film will have a smooth appearance, which is desirable in some cases. If the characteristic size is larger than about 1 mm, it will present a visible pattern to the observer. In some embodiments, the characteristic size is less than 10 mm.

If the characteristic size of the pattern elements is more than an order of magnitude and in some embodiments, more than two orders of magnitude smaller than the light exit surface of the luminaire, then the 2D deglaring film's response to light will be substantially uniform over dimensions comparable to said light exit surface of the luminaire. As such, the light distribution created by the luminaire will not be sensitive to the exact placement of the 2D deglaring film in the luminaire other than aligning prisms at ˜+−45 degrees to a major axis This is potentially advantageous for allowing tolerance in the assembly of the luminaire, and additionally potentially advantageous in allowing the product to be manufactured in sheets with large surface areas, from which 2D deglaring film can be cut from any location on the sheet without needing to align the cut to specific features other than orientation angle on the 2D deglaring film pattern, saving cost. Thus, in many cases it may be particularly advantageous that the characteristic size of pattern elements is more than an order of magnitude smaller, and in some embodiments more than two orders of magnitude smaller than the light exit surface of the luminaire in which it is employed. A typical small size for the light exit surface of a luminaire is about 50 mm circular, and a typical large size for the light exit surface of a luminaire is about a 1200 mm×600 mm rectangle.

In some embodiments, the characteristic size of pattern elements is one or two orders of magnitude smaller than the luminaire in which it is employed. In this configuration, the macroscopic optical structure is substantially uniform on the size scale of the luminaire, and to a viewer would have a consistent surface appearance, be it a smooth texture (in the case when the characteristic size is very small) or a substantially uniform pattern (for larger, more visible characteristic sizes). It is possible to choose an area on the surface of the substrate of a 2D deglaring film that encompasses several pattern elements, or is several times the characteristic size of pattern elements. This area can contain prisms with a distribution of prism orientation angles according to the design of this particular 2D deglaring film, and light illuminating that area will be affected by the prisms in accordance with the collection of prism shapes and path shapes that area of the substrate. In addition, it is possible to choose a second area of similar size in a different location of the surface of the 2D deglaring film that contains a group of prisms with substantially the same collection of prism shapes and path shapes, and have substantially the same response to incoming light. By extension, it is possible to choose areas covering the entire substrate and having substantially the same collection of prism shapes and path shapes. Given the similarity of these chosen areas, the 2D deglaring film is substantially uniform over the spatial size of the substrate.

Due to the preference in some embodiments that the characteristic size of pattern elements is significantly smaller than the size of the luminaire, and that the pattern elements are composed of a plurality of substantially parallel prisms and thus the individual prisms have a pitch that is generally smaller than the characteristic size of pattern elements, the prisms can in many embodiments be quite small, often smaller than 100 microns, and sometimes smaller than 20 microns. In some embodiments, a luminaire is provided which uses any of the 2D deglaring films of the embodiments herein to provide low high-angle luminous intensity. In some embodiments, a light source is provided which uses any of the 2D deglaring films of the embodiments herein to provide low high-angle luminous intensity.

One feature of the present teaching is that the deglaring films can be designed to be cost effective to manufacture. The 2D deglaring film according to any of the embodiments described herein can be created using many techniques known in the art. For example, the shape of the prisms can be cast onto a substrate using a suitable master mold, and thermally-curing polymer or ultraviolet (UV) light curing polymer, or the shape may be impressed into a thermoplastic substrate through compression molding or other molding, or may be created at the same time as the substrate using extrusion-embossing or injection molding.

As another example, the microstructures can be produced by replicating a master. For example, an optical diffuser can be made by replication of a master containing the desired shapes as described in U.S. Pat. No. 7,190,387 to Rinehart et al., entitled Systems And Methods for Fabricating Optical Microstructures Using a Cylindrical Platform and a Rastered Radiation Beam; U.S. Pat. No. 7,867,695 to Freese et al., entitled Methods for Mastering Microstructures Through a Substrate Using Negative Photoresist; and/or U.S. Pat. No. 7,192,692 to Wood et al., entitled Methods for Fabricating Microstructures by Imaging a Radiation Sensitive Layer Sandwiched Between Outer Layers, assigned to the assignee of the present application, the disclosures of all of which are incorporated herein by reference in their entirety as if set forth fully herein. The masters themselves may be fabricated using laser scanning techniques described in these patents, and may also be replicated to provide diffusers using replicating techniques described in these patents.

Large prism sizes make it impractical or even impossible to make flexible films. Films, when manufactured roll to roll, can be very economical. The prisms themselves, which can be manufactured quickly and economically using photo-replication with UV-curing polymers, benefit from smaller prism sizes, which consume less UV-cured polymer, saving expense. Thin films can be laminated to rigid polymer (such as acrylic or polycarbonate) sheets. Photo-replicated films of this sort laminated to rigid sheets can often be more cost effective than other methods, such as compression molding, which has high shape fidelity but is slow, or hot roll embossing, which is comparatively fast but has poorer shape fidelity, and thus poorer optical performance. When using photo-replication, it is desirable that the height of the photo-replicated layer (in this case, the prisms of a 2D deglaring film) be less than or about equal to the thickness of the polymer substrate onto which the microstructure is being photo-replicated. Having prisms of about 100-micron height makes it possible to photo-replicate on substrates as thin as about 100 microns. Having prisms of about 30-micron height enables photo-replication on substrates as thin as about 25 microns (0.001 inch) in thickness. Films with thickness in the 25-200-micron range are preferable for use as a flexible film due to low cost and low shipping weight. Films with thickness in the 12.5-75-micron range are preferable for use for lamination due to low cost.

It is also possible to manufacture films using laser holography, as known in the art. In this process, laser holography is used to create a holographic pattern that creates the desired microstructure in a photosensitive material.

It is also possible to manufacture films using projection or contact photolithography, such as used in semiconductor, display, circuit board, and other common technologies known in the art, is used to expose the microstructures into a photosensitive material. Other example systems/methods of manufacture include laser ablation, either using a mask or using a focused and modulated laser beam, is used to create the microstructures in a material. Another example manufacturing system/method includes micromachining (also known as diamond machining), known in the art, is used to create the desired microstructure from a solid material. Another example manufacturing system/method includes additive manufacturing (also known as 3D printing), known in the art, is used to create the desired microstructure in a solid material.

Variations on the structure of the deglaring films may be provided according to various embodiments described herein. For example, the substrate may be thin, such as a flexible plastic film, or thick, such as a rigid acrylic or polycarbonate sheet. It may be monolithic or include multiple layers, such as a thin plastic film laminated to a thicker rigid substrate using an adhesive layer or other lamination method. The diffuser may be substantially flat, or may take on a curvature (concave or convex; cylinder-like or dome-like) as long as the diffuser still reduces high-angle luminous intensity. Additional optical or mechanical layers may be present, such as a cladding layer of differing refractive index disposed outside of the 2D deglaring film prism layer.

Deglaring films according to embodiments described herein are designed to accept a light distribution provided by a luminaire's light source and other components (not including the deglaring film). The light distribution input to the film is transformed into a useful light distribution having a low high-angle luminous intensity. In some cases, the incoming light distribution will be Lambertian with 120-degree FWHM. In other cases, the incoming light distribution may be a narrower Lambertian (e.g., 90-degree FWHM), approximately Lambertian, or non-Lambertian. In these cases of narrower input distributions, it can still be desirable to shape the incoming light distribution using a deglaring film of the present teaching.

In some embodiments, a 2D deglaring film includes additional diffusion features such as from surface roughness, a diffusive substrate, or a diffusive second surface. Such diffusion features may increase the ability of the 2D deglaring film to hide light sources such as LEDs, and may also decrease the ability of the 2D deglaring film to reduce high-angle luminous intensity. This reduction may still be acceptable and thus may be a valid choice of tradeoff in cases where increased source hiding is desired. Diffusion can be added to a 2D deglaring film in many known ways.

In some embodiments, a respective microprism has a generally triangular cross section with sides defining a peak, the cross section taken in a plane perpendicular to the second surface of the substrate. The peak may be generally parallel to the second surface of the substrate. The peak may be a rounded peak. At least one side of the microprism may define a convex surface. The microprism may have an internal angle defined by the peak of between about 95 and 120 degrees or between about 100 and 110 degrees in various embodiments. Examples of prism cross sections are shown in FIG. 7C.

In some embodiments, adjacent microprism elements are in contact with one another. In some embodiments, the array of microprism elements includes gaps between at least some of the microprism elements, and the deglaring film further includes gap-filling microstructures in at least some of the gaps.

The deglaring film may include at least one diffusion feature including: surface roughness on at least some of the microprisms; a diffuser on the first surface of the substrate; a light scattering agent in at least some of the microprisms and/or in the substrate; and/or a diffusive coating on at least some of the microprisms.

In some embodiments, the light source is a Lambertian light source. The light source may include one or more LEDs.

In some embodiments, the deglaring film is in combination with at least one light source and a housing that is configured to hold the at least one light source and the light transmissive substrate so that light from the light source impinges on the first surface of the substrate and emerges from the second surface of the substrate with reduced high-angle luminous intensity. The housing may define a light exit surface area where the substrate is held. In various embodiments, a respective microprism element has an area on the second surface of the substrate that is at least one order of magnitude, at least two orders of magnitude, and/or at least four orders of magnitude smaller than the light exit surface area. In some embodiments, the array of microprism elements on the second surface of the substrate extends over substantially the entire light exit surface area. In some embodiments, the light source is an array of LEDs with a spacing between adjacent LEDs.

In some embodiments, the deglaring film is in combination with at least one light source wherein the light transmissive substrate is suspended under the light source so that light from the light source impinges on the first surface of the substrate and emerges from the second surface of the substrate with reduced high-angle luminous intensity.

Deglaring films may be fabricated according to various embodiments described herein by imaging onto a photo-imageable material an image of a plurality of microprisms having a geometric feature that is configured to reduce high-angle luminous intensity of light transmitted through the microprisms. The photo-imageable material is then used to replicate an image of a plurality of microprisms in and/or on a substrate, the plurality of microprisms also having a geometric feature that is configured to reduce high-angle luminous intensity of light transmitted through the microprisms. The imaging may be performed by scanning a laser across the photo-imageable material, the laser defining the image of a plurality of microprisms having the geometric feature that is configured to reduce high-angle luminous intensity of light transmitted through the microprisms.

Deglaring films according to various embodiments described herein include a light transmissive substrate having first and second opposing faces. A plurality of microprisms are on the second surface, with the microprisms having a generally triangular cross section in a plane that is perpendicular to the second surface, and the microprisms are distributed on the second surface of the substrate in different prism orientation angles of + or −45 degrees relative to machine direction of the film or relative to major axis of light fixture. The deglaring film is configured to receive light from a light source facing the first surface and reduce high-angle luminous intensity of the light emerging from the second surface. The deglaring film is also configured to increase luminous intensity of the light emerging from the second surface in a direction orthogonal to the light transmissive substrate relative to a Lambertian light distribution.

In some embodiments, the plurality of microprisms and/or interspersed microstructures substantially cover the second surface of the substrate.

Deglaring films according to various embodiments described herein include a light transmissive substrate having first and second opposing faces. An array of microprism elements is on the second surface, with a respective microprism element including a plurality of small regions such as squares or rectangle or polyhedral with prisms oriented at approximately (+−15 degrees) at + or −45 degrees with respect to major axis. An example is shown in FIG. 13. The deglaring film is configured to receive light from a light source facing the first surface and reduce high-angle luminous intensity of the light emerging from the second surface.

Various embodiments have been described above with reference to the accompanying drawings. Other embodiments may take many different forms and should not be construed as limited to the embodiments set forth herein. Rather, these embodiments are provided so that this disclosure will be thorough and complete, and will fully convey the scope of the invention to those skilled in the art.

Many different embodiments have been disclosed herein, in connection with the above description and the drawings. It will be understood that it would be unduly repetitious and obfuscating to literally describe and illustrate every combination and sub-combination of these embodiments. Accordingly, the present specification, including the drawings, shall be construed to constitute a complete written description of all combinations and sub-combinations of the embodiments described herein, and of the manner and process of making and using them, and shall support claims to any such combination or sub-combination.

In the drawings and specification, there have been disclosed embodiments of the invention and, although specific terms are employed, they are used in a generic and descriptive sense only and not for purposes of limitation, the scope of the invention being set forth in the following claims.

It is noted that any one or more aspects or features described with respect to one embodiment may be incorporated in a different embodiment although not specifically described relative thereto. That is, all embodiments and/or features of any embodiment can be combined in any way and/or combination.

### Equivalents

While the Applicant's teaching is described in conjunction with various embodiments, it is not intended that the applicant's teaching be limited to such embodiments. On the contrary, the Applicant's teaching encompass various alternatives, modifications, and equivalents, as will be appreciated by those of skill in the art, which may be made therein without departing from the spirit and scope of the teaching.

What is claimed is:

1. A deglaring film comprising a substrate having a first surface configured to accept input light along a nadir and having an input light distribution comprising a Lambertian light distribution and a second surface comprising a plurality of prism microstructures, wherein each prism microstructure has a peak-shaped cross section with an apex angle and an apex direction, the deglaring film configured to transform the input light having the Lambertian light distribution to output light emerging from the second surface along the nadir and having an output light distribution with an intensity of light at some angles greater than 60 degrees from the nadir being less than an intensity of light of the input light distribution at the some angles greater than 60 degrees from the nadir, wherein an apex angle of at least some of the plurality of prism microstructures is chosen in a range such that the output light distribution has a glare below a predetermined level in two directions.

2. The deglaring film of claim 1, wherein the glare below the predetermined level comprises a Unified Glare Rating less than seventeen.

3. The deglaring film of claim 1, wherein the apex angle of at least some of the plurality of prism microstructures is chosen to be in a range from 95 to 117 degrees.

4. The deglaring film of claim 1, wherein the plurality of prism microstructures comprises parallel prism microstructures.

5. The deglaring film of claim 1, wherein the peak-shaped cross section comprises a triangular shape.

6. The deglaring film of claim 1, wherein the peak-shaped cross section comprises a rounded trough.

7. The deglaring film of claim 1, wherein the peak-shaped cross section comprises a rounded peak.

8. The deglaring film of claim 1, wherein the peak-shaped cross section comprises convex sides.

9. The deglaring film of claim 1, wherein the peak-shaped cross section comprises concave sides.

10. The deglaring film of claim 1, wherein the second surface further comprises a plurality of two-dimensional regions, at least two of the two-dimensional regions comprising a plurality of parallel prism microstructures having apex directions with different orientations.

11. The deglaring film of claim 10, wherein the different orientations are orthogonal orientations.

12. The deglaring film of claim 10, wherein the at least two of the two-dimensional regions are tile-shaped regions positioned adjacent to each other along a tile axis and the apex directions with different orientations are an apex direction oriented at plus 45 degrees from the tile axis and an apex direction oriented at minus 45 degrees from the tile axis.

13. The deglaring film of claim 1, wherein the first surface comprises diffuser features.

14. The deglaring film of claim 1, wherein the second surface further comprises a light scattering agent in at least some of the plurality of prism microstructures.

15. The deglaring film of claim 1, wherein the output light distribution comprises an intensity of light at angles greater than 65 degrees from the nadir that is less than thirty percent of an intensity of light along the nadir.

16. The deglaring film of claim 1, wherein the output light distribution comprises an intensity of light at angles greater than 65 degrees from the nadir that is less than twenty percent of an intensity of light along the nadir.

17. The deglaring film of claim 1, wherein the substrate comprises a flat substrate.

18. The deglaring film of claim 1, further comprising a fixture wherein the apex direction is aligned at 45 degrees to a major axis of the fixture.

19. An illumination system comprising:
a) a light source that generates light along a nadir having a Lambertian light distribution; and
b) a deglaring film positioned adjacent to the light source and comprising a substrate having a first surface configured to receive as input light the generated light along the nadir having the Lambertian light distribution and a second surface comprising a plurality of prism microstructures, each prism microstructure having a peak-shaped cross section with an apex angle and an apex direction, the deglaring film configured to transform the input light having the Lambertian light distribution to output light emerging from the second surface along the nadir and having an output light distribution with an intensity of light at some angles greater than 60 degrees from the nadir being less an intensity of light of the input light distribution at the some angles greater than 60 degrees from the nadir, wherein an apex angle of at least some of the plurality of prism mictrostructures is chosen in a range such that the output light distribution has a glare below a predetermined level in two directions.

20. The illumination system of claim 19, wherein the peak-shaped cross section comprises a triangular shape.

21. The illumination system of claim 19, wherein the peak-shaped cross section comprises a rounded trough.

22. The illumination system of claim 19, wherein the peak-shaped cross section comprises a rounded peak.

23. The illumination system of claim 19, wherein the peak-shaped cross section comprises convex sides.

24. The illumination system of claim 19, wherein the peak-shaped cross section comprises concave sides.

25. The illumination system of claim 19, wherein the second surface further comprises a plurality of two-dimensional regions, at least two of the two-dimensional regions comprising a plurality of parallel prism microstructures having apex directions with different orientations.

26. The illumination system of claim 19. wherein the first surface comprises diffuser features.

27. The illumination system of claim 19. wherein the second surface further comprises a light scattering agent in at least some of the plurality of prism microstructures.
